(19) United States
(12) Patent Application Publication
(10) Pub. No.: US 2008/0011377 A1
(43) Pub. Date: Jan. 17, 2008

(54) Flexible hose

(75) Inventors: Marc Van Hooren, Bernbach (DE); Andreas Seyler, Grundau (DE); Artur Poeppel, Gelnhausen (DE)

Correspondence Address: BUCHANAN, INGERSOLL & ROONEY PC, POST OFFICE BOX 1404, ALEXANDRIA, VA, 22313-1404, US

(73) Assignee: Veritas AG, Gelnhausen (DE)

(21) Appl. No.: 11/822,640

(22) Filed: Jul. 9, 2007

(30) Foreign Application Priority Data
Jul. 14, 2006 (DE) 102006032751.9

(51) Int. Cl. F16L 11/04; F16L 11/02

(52) U.S. Cl. 138/118; 264/209.6

(57) ABSTRACT

A flexible hose is disclosed, e.g., a charge-air hose for the automobile industry. A charge-air hose has rigid and flexible sections, which can be manufactured at lower costs and is less prone to material failure during permanent use than is a conventional hose. An exemplary flexible hose comprises at least one crosslinkable material, wherein the hose has crosslinking degrees differing in portions.

### RELATED APPLICATIONS

This application claims priority under 35 U.S.C. §119 to German Application 102006032751.9 filed in Germany on Jul. 14, 2006, the entire contents of which are hereby incorporated by reference in their entireties.

### TECHNICAL FIELD

The present disclosure relates to a flexible hose, e.g., a charge-air hose for the automobile industry, and to the manufacture thereof.

### BACKGROUND INFORMATION

Pipe systems are already known that consist of both rigid and flexible components. Such pipes are e.g. used in car building as charge-air pipes, preferably in internal combustion engines with turbochargers. The connections between supercharger, resonator, intercooler and engine intake are regarded as charge-air pipes. Such charge-air hoses are dynamically highly stressed constructions. Typical charge-air hoses have a wall comprising a plurality of layers of elastomeric material.

Flexible pipe components are used whenever relative movements between engine and chassis have to be accommodated by the charge-air pipe. This is the case with almost all vehicles as the charge-air cooler is secured to the chassis. Elastomer-based flexible hoses have here turned out to be useful, a fabric-reinforced molded hose of elastomer forming the soft component. Thermoplastic elastomers, such as copolyamide elastomers (TPE-A), elastomeric polyetheresters (TEE-E), polyurethane elastomers (TPE-U) or elastomer-modified thermoplastics are also suited for the soft component.

The rigid pipe components or the hard components of the corresponding pipe are normally formed from metal pipes or from glass fiber-reinforced thermoplastic tubes of polyamide (PA), polybutyleneterephthalate (PBT), polyphenylene sulfide (PPA), etc.

Such pipe components show very little flexibility. They are used whenever a fastening place is required on the charge-air pipe or the pipe must not get deformed or shifted in a specific area.

Charge-air tubes are normally produced by means of a three-dimensional blow molding technique or in an injection-molding process, the hard and soft components being connected by connection elements such as couplings or hose clamps.

The conventional hoses with rigid and flexible sections have, however, the drawback that for the manufacture of the components different materials must be provided, processed and subsequently connected in a permanent way, with leakage often arising at the points of connection during permanent use within the high temperature range. In addition, when the hoses are used in the form of charge hoses, the great dynamic loads, particularly increasing charge pressures and increasing performance of the internal combustion engines, will cause damage time and again, especially at the places of connection.

### SUMMARY

A hose is disclosed, e.g., a charge-air hose with rigid and flexible sections that can be produced at lower costs and is less prone than a conventional hose to material failure during permanent use.

An exemplary flexible hose is disclosed, comprising at least one crosslinkable material, the hose exhibiting different degrees of crosslinking in portions. Thanks to the crosslinking of the flexible tube in portions, it is possible to form substantially rigid sections on the flexible hose, so that, in contrast to conventional pipes, the exemplary hose need not be assembled from different hard/soft components. Therefore, the exemplary hose is much less prone to leakage than conventional hoses. For instance, in the exemplary hose the pipe need also not be assembled from individual hard and soft components. This also accomplishes a reduced weight of the whole pipe because the exemplary hose does not require any connection elements, such as couplings or hose clamps. In addition, there are no acquisition costs for the connection elements.

The mechanical properties of the hose are modified by crosslinking with respect to the stiffness module (E modulus), strength and hardness so that rigid or tubular portions are formed because there is a direct relationship between stiffness or elasticity and crosslinking degree. Tensile strength, elongation at break, and hardness will particularly be rising at increased temperature loads (increase in dimensional stability under heat) due to the resulting crosslinking places. At the same time, the dynamic properties are improved with respect to the alternating bending strength and the internal-pressure creep behavior, which is also true for the creep resistance and the resistance to stress cracking.

Moreover, the resistance to chemicals, particularly resistance to hydrolysis and oils, as well as the swelling behavior are improved by crosslinking. A further improvement is achieved with respect to the setting behavior and deformation under pressure. Moreover, the hose is more resistant to aging.

Due to the crosslinking degrees that are differing in portions, the hose has different mechanical and dynamic properties from portion to portion. The hose can be manufactured as one part.

In an exemplary embodiment, the hose shows different crosslinking degrees in axial direction. A flexible section can be provided in axial direction between two rigid sections.

In an exemplary embodiment, the hose has different crosslinking degrees in circumferential direction. This has the advantage that, when the hose is subjected to bending stresses, a flexible section may be formed as a bending back while a less flexible section forms the bending channel, thereby preventing buckling also in the case of a strong curvature.

In a further exemplary embodiment the hose shows a lower crosslinking degree in a strongly curved section than in a section that is only slightly curved or is substantially straight. As a result, bending forces that are arising are absorbed in a better way.

In a further exemplary embodiment, the crosslinkable material comprises a crosslinkable thermoplastic material and a thermoplastic elastomer. It is here expedient that both materials are chemically equivalent or are made from the same class of materials, e.g. PA6 and thermoplastic elastomer based on PA6. This enhances adhesion in the area of the boundary layer on account of compatible materials, i.e., interdiffusion of the polymer chains in the area of the boundary layer and by subsequent radiation-induced crosslinking. In the case of fiber-reinforced materials, an optimized fiber matrix adhesion is accomplished in addition. The mechanical dynamic properties as well as the temperature stability particularly of the soft component as the weakest member of the exemplary hose are influenced and optimized by a selective selection among the several components. Thermoplastic elastomers and thermoplastics are normally not crosslinked and can also not be crosslinked chemically because of the high processing temperatures during extrusion or in injection molding or blow molding processes, which is in contrast to elastomers. The materials of these classes of substances, however, can be crosslinked by means of high-energy radiation (normally electron radiation with doses of about 80 to 200 kGy).

In a further exemplary embodiment, a crosslinking promoter or co-activator is added as an additive component. Due to the selection of the crosslinking promoter or co-activator and the content thereof it is possible to adjust the crosslinking degree or the crosslinking density of the hose in compliance with the requirements. Examples of suitable co-activators are trifunctional unsaturated compounds, such as triallylisocyanurate (TAIC), triallylcyanurate (TAC), trimethylallylisocyanurate (TMAIC), trimethylolpropanetriacrylate (TMPTR), etc. The co-activators may form bifunctional or multifunctional network nodes. Similar to peroxide crosslinking, reactive radicals are formed in the first step during irradiation, namely on the polymer main chain or on the functional polymer groups, said radicals then reacting with the co-activators and interconnecting several polymer chains, resulting in the formation of a network in a way similar to that of the elastomers. This changes the basic properties of the thermoplastic elastomers or thermoplastic materials fundamentally, and said properties are e.g. optimized with respect to the use in turbocharger systems.

In a further exemplary embodiment, sectionwise crosslinking is accomplished by irradiation. β- or γ-rays can be used. In comparison with peroxidic crosslinking or silane crosslinking, irradiation crosslinking has the advantage that the hose section to be irradiated can be defined exactly.

In a further exemplary embodiment the hose comprises a reinforcing material. This makes the hose more resistant to pressure. A fiber-reinforced, thermoplastic matrix or a fiber-reinforced matrix of thermoplastic elastomers has turned out to be particularly advantageous.

In a further exemplary embodiment, the hose is glass fiber-reinforced. Glass fiber materials have a particularly high tensile strength together with a low weight and they can be processed easily. A glass fiber-reinforced hose is distinguished by particularly high thermomechanical loadability due to its high stiffness.

In another exemplary embodiment, the hose is configured as a charge-air pipe for automobiles. Therefore, the disclosure is also concerned with the use of a flexible hose according to one of the preceding embodiments as a charge-air pipe in the automobile sector. The particular properties of the exemplary hose can be accentuated in a particularly advantageous way when the hose is used as a charge-air pipe in the automobile sector.

Furthermore, the disclosure relates to an exemplary method for manufacturing a flexible hose having crosslinking degrees differing in portions, the method comprising the steps of: providing a flexible hose, including at least one crosslinkable material, masking sections of the hose that are not to be crosslinked, and crosslinking sections of the hose that are to be crosslinked. The exemplary method forms strictly delimited, flexible and rigid sections in a one-part hose.

In exemplary embodiment, crosslinking is accomplished by irradiation. β- or γ-rays are particularly preferred. Moreover, the crosslinkable material preferably comprises a crosslinking promoter or co-activator as an additive component. The degree of crosslinking is adjustable through the radiation dose and the amount of the crosslinking promoter or co-activator.

In a further exemplary embodiment, a radiation-shielding metal foil is used for masking. Metal foils can be shaped without any difficulties and the parts of the hose that are not to be crosslinked can thereby be shielded particularly easily.

The present invention will now be described in detail with reference to the enclosed drawings.

### BRIEF DESCRIPTION OF THE DRAWINGS

FIG. 1 shows an exemplary hose with crosslinked end sections and a substantially uncrosslinked central section.

FIG. 2 shows an exemplary hose with crosslinked end sections and a substantially uncrosslinked curved central section, the hose comprising a reinforcing material and the central section being given a corrugated shape.

### DETAILED DESCRIPTION

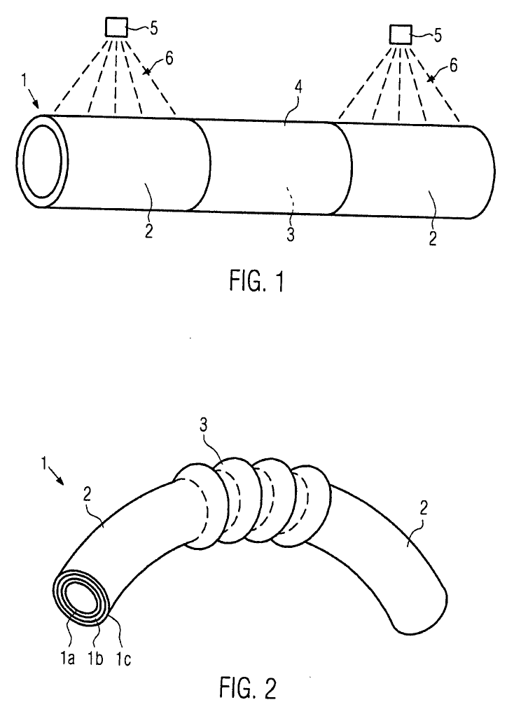

FIG. 1 shows an exemplary flexible hose 1 having at least one crosslinkable material, the hose 1 showing crosslinking degrees differing in portions. In the axial direction of the flexible hose 1 shown in FIG. 1, crosslinked sections 2 and substantially uncrosslinked sections 3 are arranged in alternating fashion. To be more specific, the end sections 2 of the hose 1 are crosslinked, whereas the central section 2 is substantially uncrosslinked. In the crosslinked sections 2, the hose 1 is substantially rigid and has a higher crosslinking degree than in the substantially uncrosslinked section 3 in which the hose 1 is flexible. The hose 1 may have several crosslinked and uncrosslinked sections that are distributed in any desired way over the hose wall.

For instance, the hose may show different crosslinking degrees in axial direction and/or in circumferential direction, i.e., it may comprise substantially rigid and flexible sections.

The configuration of substantially rigid and flexible sections depends on the use desired for the hose 1.

The crosslinkable material can be a thermoplastic material or a thermoplastic elastomer. By analogy with the base polymers of the thermoplastic materials, corresponding thermoplastic elastomers such as TPE-A and TEE-E types (optionally, glass fiber-reinforced) are crosslinkable by irradiation by adding co-activators/crosslinking promoters. Particularly suited materials are copolyamide elastomers (TPE-A), elastomeric polyetheresters (TEE-E), polyurethane elastomers (TPE-U), elastomer-modified thermoplastics, and mixtures thereof.

In an exemplary embodiment the crosslinkable material is used in the form of a single-component system. The single-component system is particularly easy to handle and to provide. After having been shaped, the hose is sequentially crosslinked in a downstream step. Optimum adhesion of the different segments is accomplished by material identity. This, in turn, enhances flexibility with respect to construction and design of the hose and is conducive to the implementation of optimized properties. As an additional advantage, production wastes or unused materials can be re-used because the crosslinking operation is only carried out in a subsequent operative step. If TPE-A or TEE-E is used for this embodiment as the crosslinkable material, it is of advantage if these materials are modified for cross-linking with functional groups or double bonds in the material. This is e.g. accomplished by the use of partly unsaturated polyethers or soft blocks of polyetherester. This accomplishes not only a crosslinking of the amide or ester functions in the partly crystalline phases, but the soft blocks are also crosslinked in a three-dimensional way.

In a further exemplary embodiment, the crosslinkable material is used in the form of a two-component system. This is above all of advantage if increased demands are made on the stiffness of the hard component, particularly in connection with increased temperatures and pressures. Hard/soft composites consisting of a suitable thermoplastic material and of the corresponding thermoplastic elastomer, such as PA6, PA 612 and TPE-A (GF optional) or PBT and TEE-E, can be used as the materials. Thanks to the use of the two-component system in the case of chemically equivalent materials, adhesion can be improved in the area of the boundary layer due to material compatibility. An optimized adhesion is accomplished in the boundary layer by interdiffusion of the polymer chains in the area of the boundary layer and by subsequent crosslinking. Moreover, this optimizes the mechanical dynamic properties as well as the temperature stability, particularly of the soft component.

The sectionwise crosslinking of the hose can be accomplished by irradiation. β- or γ-rays are here particularly preferably used.

Preferably, the crosslinkable material further comprises a crosslinking promoter or co-activator as the additive component. The crosslinking promoter is only needed in small quantitative fractions. The crosslinking degree or crosslinking density of the hose can each time be set in accordance with the requirements by selecting the crosslinking promoter and its content. Examples of suitable crosslinking promoters/co-activators are trifunctional unsaturated compounds, such as triallylisocyanurate (TAIC), triallylcyanurate (TAC), trimethylallylisocyanurate (TMAIC), trimethylolpropanetriacrylate (TMPTR). These compounds react in different ways to irradiation, resulting in different crosslinking degrees in the case of an identical dose.

The hose according to FIG. 2 comprises a plurality of layers 1a, 1b, 1c and is formed in sections as a corrugated hose. The hose 1 comprises crosslinked and rigid end sections 2 and the flexible and substantially uncrosslinked central section 3. The corrugation is formed in the curved central section 3 of the hose 1. The cross-linkable material can form the inner layer 1a and/or the outer layer 1c. In addition, a reinforcing layer 1b is provided between the inner layer 1a and the outer layer 1c. The hose 1 can be reinforced with a reinforcing material, particularly with glass fibers. Alternatively, the reinforcing material may also be embedded completely in the crosslinkable material. The multilayer structure as symbolized in FIG. 2 just serves the purpose of illustration. As an alternative or in addition to a reinforcing layer or a reinforcing material, one or several barrier layer(s) of barrier plastics adapted to be crosslinked by radiation, for instance ethylenevinyl alcohol copolymer (EVOH) or ethylene-tetrafluoroethylene (ETFE), may be provided that act as a barrier to specific substances (e.g. certain fuels, oil, blow-by condensate, or the like).

An exemplary manufacturing method of the hose will be described hereinafter with reference to the enclosed figures:

First of all, a flexible hose 1 is provided, comprising at least one crosslinkable material. The hose 1 can be entirely made in an injection molding process and is substantially uncrosslinked and flexible. Subsequently, the sections of the hose 1 that are no to be further crosslinked are masked or covered with a masking 4. The masking 4 prevents those sections 3 of the hose 1 that are not to be further crosslinked from being subjected to further crosslinking. The masking 4 is configured in the case of irradiation crosslinking as a radiation-shielding means, e.g. as a metal foil 4.

After the sections 3 of the hose 1 that are not to be further crosslinked have been masked, the sections 2 that are to be further crosslinked and not covered by the masking 4 are subjected to the action of a crosslinking agent 6 and are crosslinked. In the case of irradiation crosslinking, the sections 2 of the hose 1 to be crosslinked are irradiated by a radiation source 5, the crosslinking reaction being started in the irradiated portions of the crosslinkable material. High-energy beta (β-) or gamma (γ-) rays are preferably used as crosslinking agents 6. The properties of the crosslinkable material can be influenced by way of a targeted selection of the co-activator content and the radiation dose and can be set in compliance with the desired future use.

After the hose 1 has been subjected to the action of the crosslinking agent 6, the masking 4 of the hose 1 is removed. In the sections 2 which are to be crosslinked and pertain to the crosslinkable material of the hose 1, the degree of crosslinking is locally increased. In the sections 3 of the crosslinkable material of the hose 1 that have been covered by the masking 4, the crosslinking degree is much smaller than in the sections 2 acted upon by the crosslinking agent 6. For instance, the hose 1 or the crosslinkable material of the hose 1 comprises different crosslinking degrees in portions and, since there is a direct relation between strength and crosslinking degree, it has degrees of strength differing from portion to portion.

The features of design of the hose according to the invention, particularly the selection of the material, including the additive component, the layered structure, the corrugation, the curvature and the arrangement of the substantially uncrosslinked and crosslinked portions can be defined at will and can each be determined with respect to the specific application of the hose.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A flexible hose, comprising at least one crosslinkable material, the hose having crosslinking degrees differing in portions.

2. The flexible hose according to claim 1, wherein the hose has different crosslinking degrees in axial direction.

3. The flexible hose according to claim 1, wherein the hose has different crosslinking degrees in circumferential direction.

4. The flexible hose according to claim 1, wherein the hose has a lower crosslinking degree in a curved section than in a substantially straight section.

5. The flexible hose according to claim 1, wherein the hose comprises a crosslinking promoter or co-activator as an additive component.

6. The flexible hose according to claim 1, wherein the hose comprises sections that are crosslinked in portions, and sections that are substantially uncrosslinked in portions.

7. The flexible hose according to claim 1, wherein crosslinked sections and substantially uncrosslinked sections are alternating in the axial direction of the hose.

8. The flexible hose according to claim 1, wherein the hose is radiation-crosslinked in sections.

9. The flexible hose according to claim 1, wherein the hose comprises a reinforcing material.

10. The flexible hose according to claim 1, wherein the hose is glass fiber-reinforced.

11. The flexible hose according to claim 1, wherein the crosslinkable material comprises a plastic material selected from the group consisting of the thermoplastic elastomers.

12. The flexible hose according to claim 1, wherein the crosslinkable material comprises a crosslinkable thermoplastic material and a corresponding thermoplastic elastomer.

13. The flexible hose according to any one of the preceding claims, wherein the hose is configured as a charge-air pipe for automobiles.

14. Use of a flexible hose according to any one of the preceding claims as a charge-air pipe in the automobile sector.

15. A method for manufacturing a flexible hose having crosslinking degrees differing in portions, comprising the steps of: providing a flexible hose, including at least one crosslinkable material, masking sections not to be crosslinked and pertaining to the hose with a masking, and crosslinking sections to be crosslinked and pertaining to the hose by way of a crosslinking agent acting on said sections.

16. The method according to claim 15, wherein radiation is used as the crosslinking agent.

17. The method according to claim 15, wherein the masking comprises a radiation-shielding material.

18. The method according to claim 17, wherein the masking comprises a metal foil.

19. The flexible hose according to claim 12, wherein the hose is configured as a charge-air pipe for automobiles.

20. Use of a flexible hose according to claim 13 as a charge-air pipe in the automobile sector.
